(19) United States
(12) Patent Application Publication
(10) Pub. No.: US 2011/0181513 A1
(43) Pub. Date: Jul. 28, 2011

(54) Driving Device, Driving Method and Portable Electronic Display Device

(76) Inventors: Wen-Chin Wu, Taipei Hsien (TW); Chih-Kang Chen, Taipei Hsien (TW); Teng-Yi Chiu, Taipei Hsien (TW); Chia-Hsien Li, Taipei Hsien (TW); Chuan-Cheng Fu, Taipei Hsien (TW); Shih-Lin Chiu, Taipei Hsien (TW)

(21) Appl. No.: 12/894,163

(22) Filed: Sep. 30, 2010

(30) Foreign Application Priority Data
Jan. 22, 2010 (TW) 099101714

(51) Int. Cl. G06F 3/045; G06F 3/038; G09G 5/00

(52) U.S. Cl. 345/169; 345/204; 345/174

(57) ABSTRACT

A driving device for a portable electronic display device, capable of adapting to a holding direction of a user and driving the portable electronic display device, includes a plurality of sensing units deposited at edges of the portable electronic display device, for sensing a holding status of the user, to generate a plurality of sensing results, and a control module for determining the holding direction of the user according to the plurality of sensing results, and adjusting operations of the portable electronic display device accordingly.

### BACKGROUND OF THE INVENTION

1. Field of the Invention

The present invention relates to a driving device, driving method and portable electronic display device, and more particularly, to a driving device, driving method and portable electronic display device capable of sensing a holding direction of a user, and adaptively adjusting operations of the portable electronic display device.

2. Description of the Prior Art

An electronic book (E-book) is a portable electronic display device similar to a book, and is utilized for displaying digitalized book contents. Generally, a weight and a size of an E-book are suitable for hand-held operations, such that a user can read the E-book anywhere and anytime. However, positions of key pads and a screen of the conventional E-book are fixed, which indirectly limits holding manners and operations, causing inconvenience.

For example, FIG. 1 is a schematic diagram of a conventional E-book 10. In the E-book 10, a display screen 100 displays digitalized book contents, and a roller 102 controls page-up and page-down. Therefore, a user can change images displayed by the display screen 100 via the roller 102 when utilizing the E-book 10 to read texts or pictures. As shown in FIG. 1, the roller 102 is on the right side of the display screen 100. In other words, the most appropriate control manner is that the user holds the right side of the E-book 10 with a right hand, and rolls the roller 102 with a right thumb. Under such a situation, if the user cannot keep the right hand to operate the E-book 10 under some circumstances, such as during commuting, this control manner causes great inconvenience.

In addition, in the E-book 10, a position of the roller 102 relative to the display screen 100 is fixed. Under such a situation, if the E-book 10 is rotated by 90 degrees to display the book contents in a widescreen mode, the roller 102 will be above or below the images, such that the user cannot smoothly operate the E-book 10, causing inconvenience as well.

Therefore, how to determine the holding manner of the user and adjust a control method accordingly has become an important issue in development of the E-book.

### SUMMARY OF THE INVENTION

It is therefore an objective of the present invention to provide a driving device, driving method and portable electronic display device.

The present invention discloses a driving device for a portable electronic display device, capable of adapting to a holding direction of a user and driving the portable electronic display device. The driving device includes a plurality of sensing units, deposited at edges of the portable electronic display device, for sensing a holding status of the user, to generate a plurality of sensing results, and a control module, for determining the holding direction of the user according to the plurality of sensing results, and adjusting operations of the portable electronic display device accordingly.

The present invention further discloses a portable electronic display device capable of adapting to a holding direction of a user and operating. The portable electronic display device includes a screen, an image processing unit, for displaying a digital content via the screen, a plurality of key pads, for controlling the image processing unit, and a driving device. The driving device includes a plurality of sensing units, deposited at edges of the portable electronic display device, for sensing a holding status of the user, to generate a plurality of sensing results, and a control module, for determining the holding direction of the user according to the plurality of sensing results, and adjusting operations of the image processing unit and the plurality of key pads accordingly.

The present invention further discloses a driving method for a portable electronic display device, capable of adapting to a holding direction of a user and driving the portable electronic display device. The driving method includes sensing a holding status of the user, to generate at least one sensing results, and determining the holding direction of the user according to the at least one sensing results, and adjusting operations of the portable electronic display device accordingly.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a conventional electronic book.

FIG. 2A is a schematic diagram of a portable electronic display device according to an embodiment of the present invention,

FIG. 2B is a functional block diagram of the portable electronic display device in FIG. 2A.

FIG. 3A and FIG. 3B are schematic diagrams of the portable electronic display device in FIG. 2A in a vertical display mode.

FIG. 4A and FIG. 4B are schematic diagrams of the portable electronic display device in FIG. 2A in a horizontal display mode.

FIG. 5A and FIG. 5B are a front-view diagram and a sectional-view diagram of a touch screen, respectively.

FIG. 6 is a schematic diagram of another portable electronic display device according to an embodiment of the present invention.

FIG. 7A to FIG. 7D are schematic diagrams of corresponding operations of the portable electronic display device in FIG. 6.

FIG. 8A and FIG. 8B are schematic diagrams of a portable electronic display device in two operating modes according to an embodiment of the present invention.

FIG. 9 is a schematic diagram of a driving process according to an embodiment of the present invention.

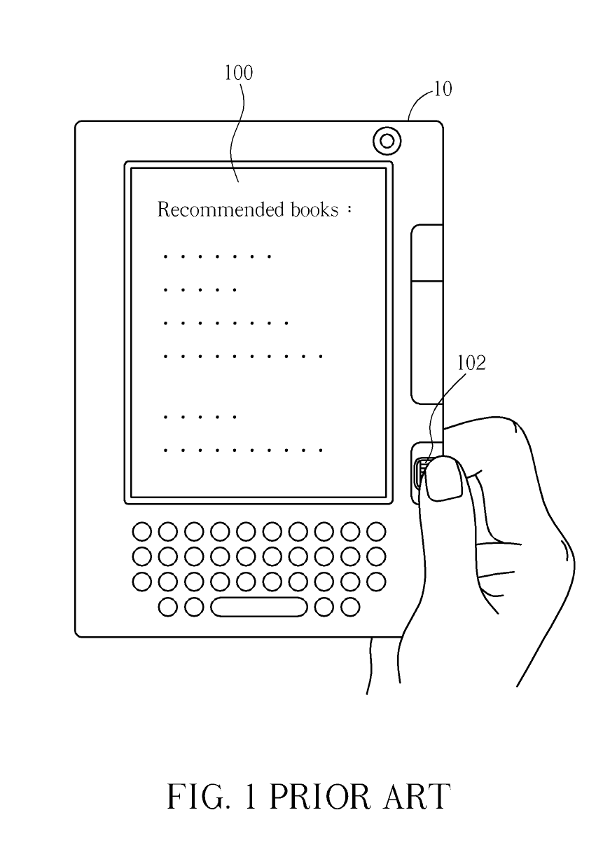

### DETAILED DESCRIPTION

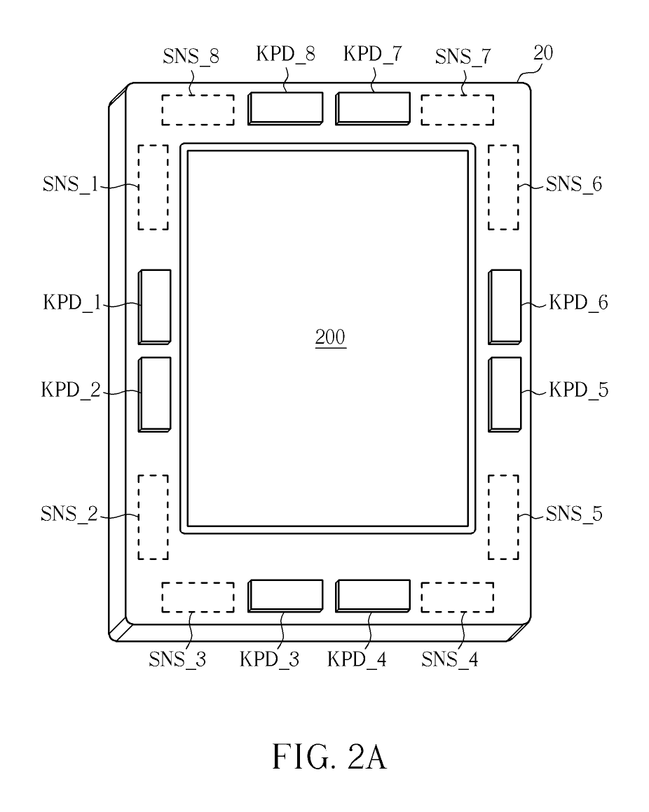

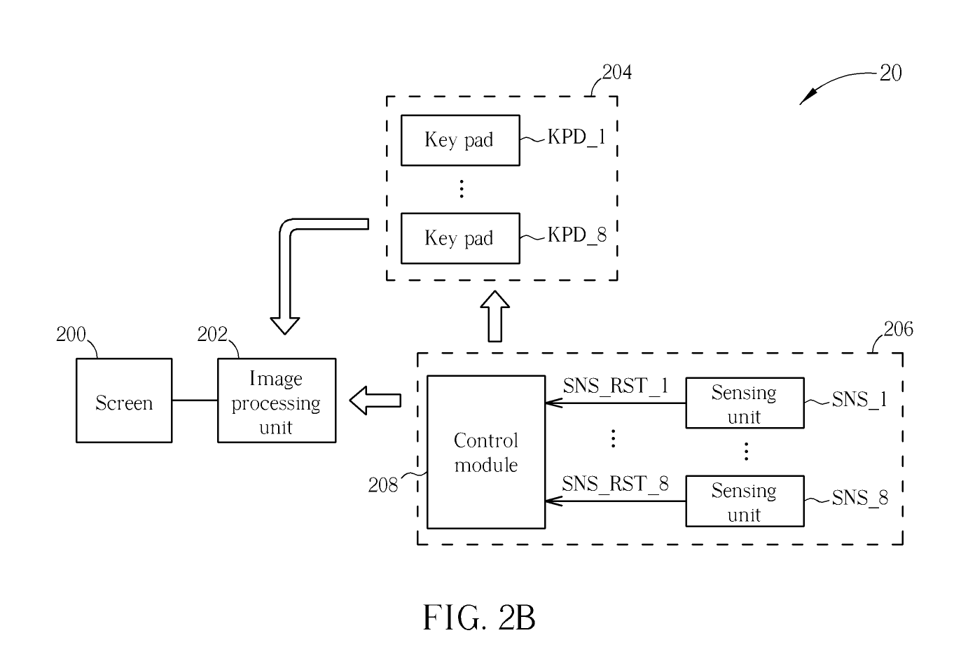

Please refer to FIG. 2A and FIG. 2B. FIG. 2A is a schematic diagram of a portable electronic display device 20 according to an embodiment of the present invention, and FIG. 2B is a functional block diagram of the portable electronic display device 20. The portable electronic display device 20 includes a screen 200, an image processing unit 202, an input interface 204 and a driving device 206. The image processing unit 202 displays digital contents, such as texts, pictures, via the screen 200. The input interface 204 includes key pads KPD_1˜KPD_8, for generating control signals to the image processing unit 202, to control operations of the image processing unit 202. The driving device 206 includes sensing units SNS_1˜SNS_8 and a control module 208. As shown in FIG. 2A, the sensing units SNS_1˜SNS_8 are deposited around the portable electronic display device 20, for sensing a holding status of a user, and generating sensing results SNS_RST_1˜SNS_RST_8 accordingly. The control module 208 determines a holding direction of the user according to the sensing results SNS_RST_1˜SNS_RST_8 generated by the sensing units SNS_1˜SNS_8, and adjusts operating manners or conditions of the image processing unit 202 and the key pads KPD_1˜KPD_8 accordingly.

In short, in the portable electronic display device 20, the driving device 206 senses touch positions of the user and determines the holding direction accordingly, so as to adjust a display direction of the screen 200, definitions of the key pads KPD_1˜KPD_8, etc, in order to enhance convenience. The following description will illustrate operating principles of the invention with different figures. However, noticeably, FIG. 2A and FIG. 2B are only utilized for illustrating the concept of the present invention, and are not limited to these. For example, the number, material, positions of key pads and sensing units can be modified, which is detailed as follows.

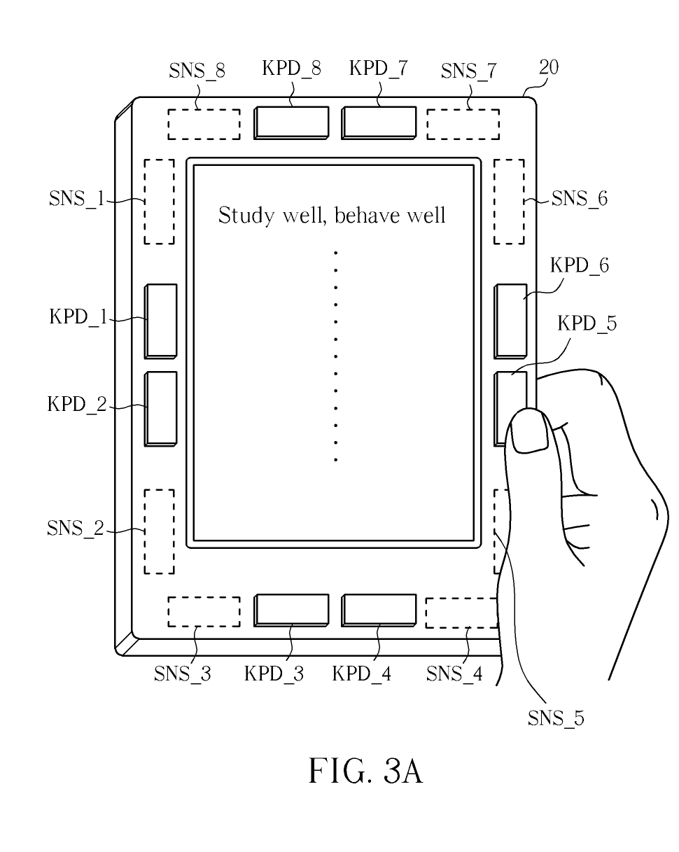

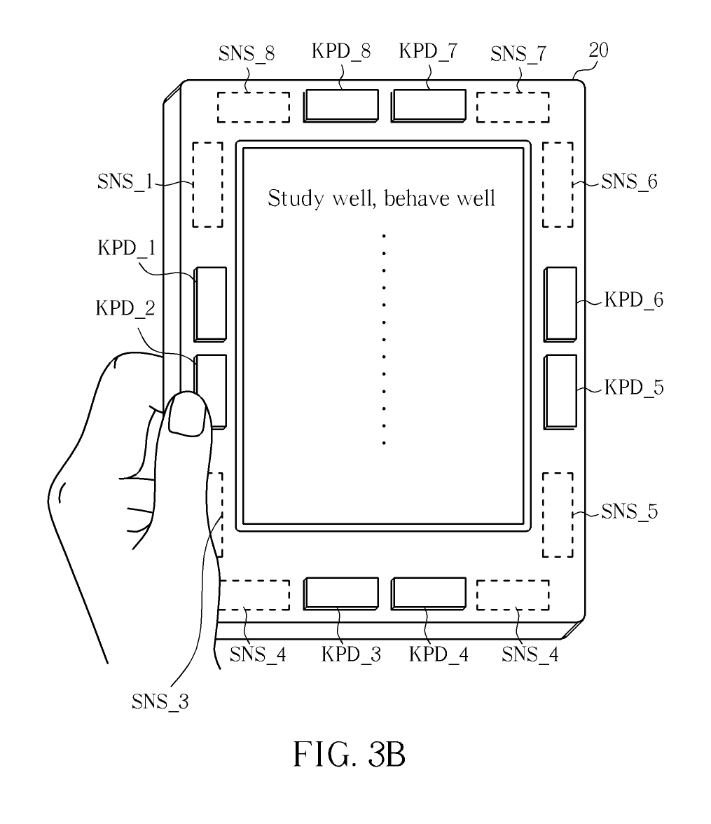

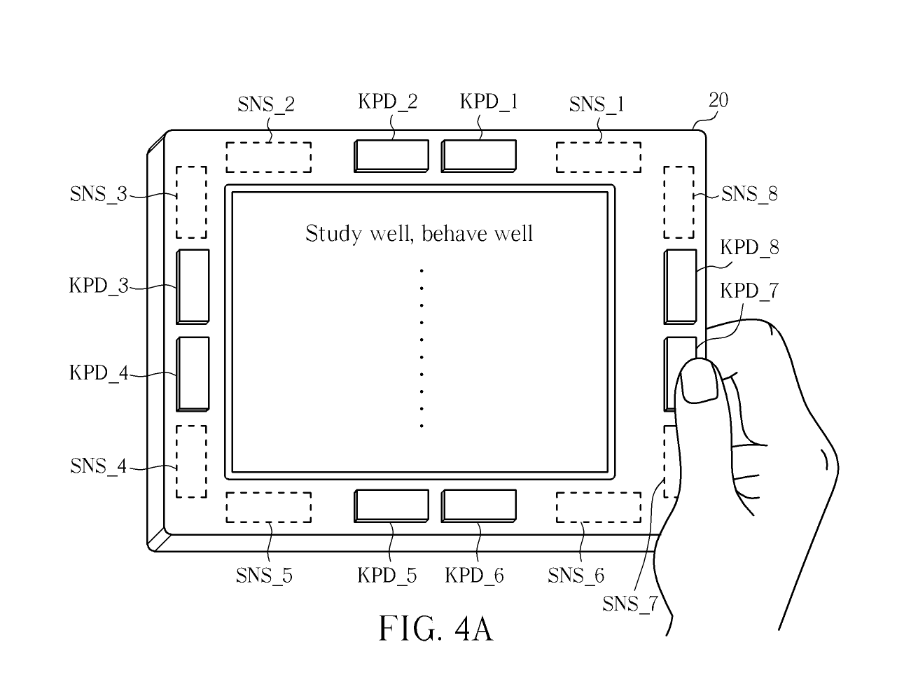

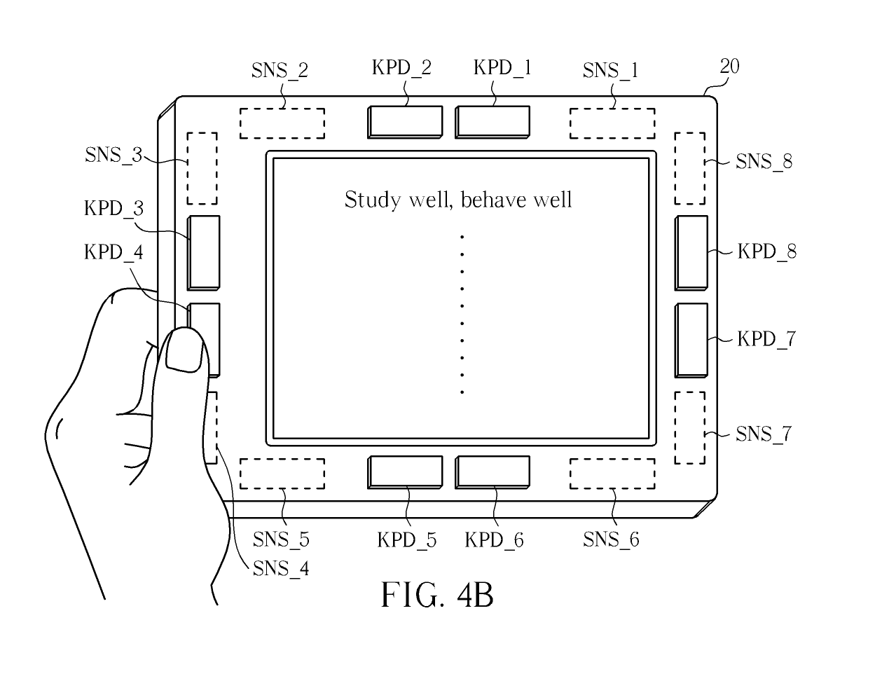

Please refer to FIG. 3A, FIG. 3B, FIG. 4A, and FIG. 4B. FIG. 3A and FIG. 3B are schematic diagrams of the portable electronic display device 20 in a vertical display mode, and FIG. 4A and FIG. 4B are schematic diagrams of the portable electronic display device 20 in a horizontal display mode. In FIG. 3A, FIG. 3B, FIG. 4A, FIG. 4B, texts “study well, behave well . . . ” displayed by the screen 200 are merely utilized as example for digitalized text contents, to illustrate adjusting results of the display direction, and do not have any specific meaning or make any limitation to the present invention. First, in FIG. 3A, the user holds the portable electronic display device 20 with a right hand, and controls the key pads KPD_5, KPD_6 with a right thumb. Therefore, when the right hand touches (or approaches) the sensing unit SNS_5, the sensing unit SNS_5 can report the holding position of the user to the control module 208 via the sensing result SNS_RST_5. By doing so, the control module 208 can determine that the user adopts a vertical reading mode, so as to display text contents as the example shown in FIG. 3A. Similarly, in FIG. 3B, the user touches (or approaches) the sensing unit SNS_2 with a left hand, such that the control module 208 can also determine that the user adopts the vertical reading mode, so as to display text contents as the example shown in FIG. 3B.

If the user rotates the portable electronic display device 20 90 degrees clockwise, i.e. adopting a horizontal reading mode, when the right hand touches (or approaches) the sensing unit SNS_7 or the left hand touches (or approaches) the sensing unit SNS_4, the control module 208 can also determine that the user adopts the horizontal reading mode, so as to display text contents as the examples shown in FIG. 4A, FIG. 4B.

As can be seen from the above, the control module 208 can determine the holding direction of the user according to the sensing results SNS_RST_1˜SNS_RST_8 generated by the sensing units SNS_1˜SNS_8, so as to adjust the display direction via the image processing unit 202. Other than adjusting the display direction, the control module 208 can further adjust functional definitions of the key pads KPD_1˜KPD_8. For example, in FIG. 3A and FIG. 3B, the key pads KPD_1, KPD_6, which can be operated with the left and right thumb easily, are defined as “page up”, and the key pads KPD_2, KPD_5 are defined as “page down”, the key pads KPD_3, KPD_4, which cannot be operated with the left and right thumbs easily, are respectively defined as “previous book” and “next book”. On the contrary, in FIG. 4A and FIG. 4B, the key pads KPD_8, KPD_3 are defined as “page up”, the key pads KPD_7, KPD_4 are defined as “page down”, and the key pads KPD_5, KPD_6 are respectively defined as “previous book” and “next book”.

Noticeably, FIG. 3A, FIG. 3B, FIG. 4A, and FIG. 4B are only utilized for illustrating available operations of the portable electronic display device 20, which are not limited to these. For example, other than 90-degree clockwise rotation in FIG. 4A, FIG. 4B, the present invention can also be applied for 90-degree counterclockwise rotation, or upside down. The spirit of the present invention is to sense the holding position of the user, and adjust the display direction or the definitions of the key pads accordingly, in order to enhance convenience for operations with one hand. Operations of switching the same digital content into different display directions via the image processing unit 202, or adjusting the definitions of the key pads KPD_1˜KPD_8 are ordinary skills in the art. Thus, those skilled in the art should make different alterations and modifications according to system requirements, which are not limited to this. For example, in FIG. 2B, a relation between the control module 208 and the input interface 204 is denoted by a one-way arrow to illustrate the control concept, but in practical, there are many methods for adjusting the definitions of the key pads KPD_1˜KPD_8. For example, if the input interface 204 includes corresponding controllers of the key pads KPD_1˜KPD_8, the control module 208 can adjust settings of the controllers, to adjust the definitions of the key pads KPD_1˜KPD_8; if the key pads KPD_1˜KPD_8 are directly connected to the image processing unit 202 (i.e. via different pins), the control module 208 can also adjust the setting of the image processing unit 202, to adjust the definitions of the key pads KPD_1˜KPD_8. Therefore, in FIG. 2B, the connection relation between the control module 208 and the image processing unit 202 or the input interface 204 is only utilized for illustrating the operating principle of the present invention, and is not utilized for limiting physical connection wires.

On the other hand, the portable electronic display device 20 includes a total of 8 key pads and 8 sensing units, and this configuration is only an exemplary embodiment of the present invention. The keypads KPD_1˜KPD_8 can be any forms, appearances or materials, as long as corresponding control signals can be generated when the key pads KPD_1˜KPD_8 are pressed by the user. Similarly, a variety of alterations of the sensing units SNS_1˜SNS_8 can be made. For example, if the sensing units SNS_1˜SNS_8 are realized by optical resistors, the touch positions of the user can be sensed via an optical sensing method; if the sensing units SNS_1˜SNS_8 are realized by infrared receivers, the touch positions of the user can be sensed via an infrared sensing method; if the sensing units SNS_1˜SNS_8 are realized by capacitive sensing wires, the touch positions of the user can be sensed via a capacitive sensing method. Certainly, realizations of the sensing units SNS_1˜SNS_8 are not limited to the optical resistors, the infrared receivers or the capacitive sensing wires, and other elements capable of sensing touches of the user can be applied in the present invention as well.

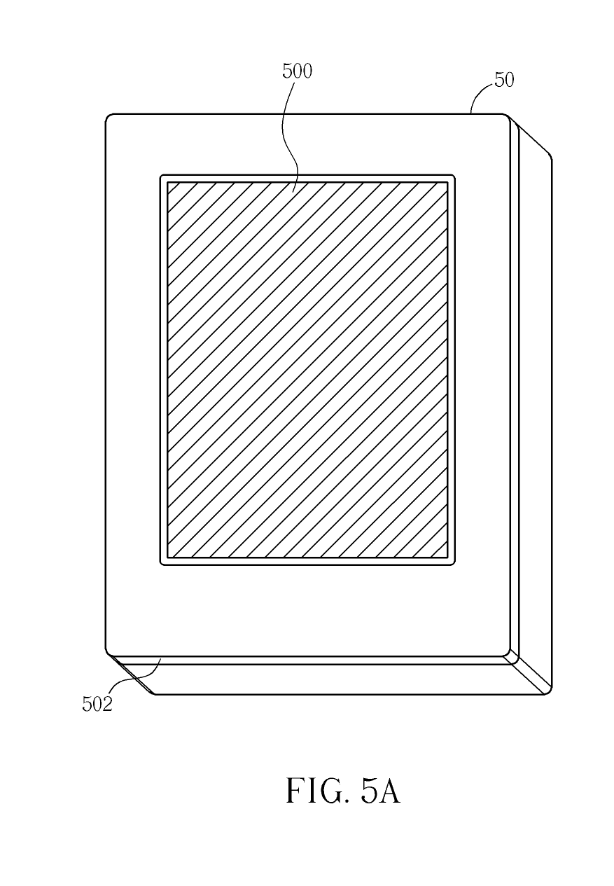

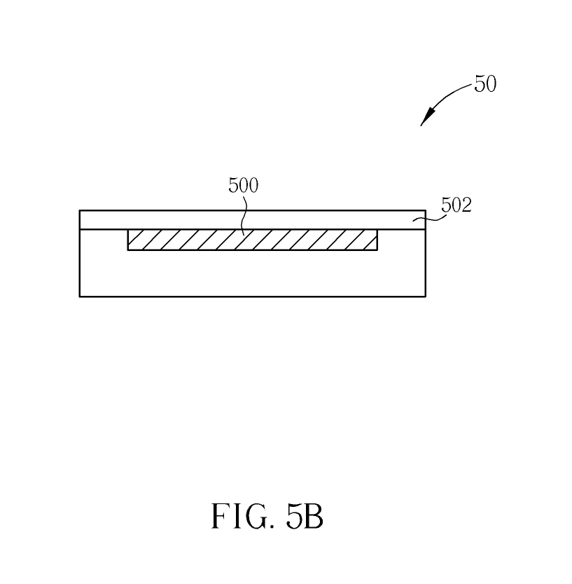

Furthermore, in the above description, the key pads KPD_1˜KPD_8 and the sensing units SNS_1˜SNS_8 are considered as different elements, but in practical, the key pads KPD_1˜KPD_8 and the sensing units SNS_1˜SNS_8 may be elements with the same structure according to different applications. For example, the screen 200 can be realized by a touch screen, and the key pads KPD_1˜KPD_8 and the sensing units SNS_1˜SNS_8 can be realized by sensing strings in a non-display area. In detail, please refer to FIG. 5A and FIG. 5B, which are a front-view diagram and a sectional-view diagram of a touch screen 50, respectively. The touch screen 50 can simultaneously realize the screen 200, the key pads KPD_1˜KPD_8 and the sensing units SNS_1˜SNS_8 of the portable electronic display device 20. Generally, the touch screen includes a display device and a transparent sensing thin film. Operating principals of the transparent sensing thin film are the same as a touch pad, and the difference is that the transparent sensing thin film is made by a transparent material. Therefore, as shown in FIG. 5A and FIG. 5B, an area of a transparent sensing thin film 502 of the touch screen 50 can be expanded, such that a sensing part exceeding a display area of a display device 500 can be utilized for realizing the key pads KPD_1˜KPD_8 and the sensing units SNS_1˜SNS_8. On the contrary, the display area of the display device 500 can be narrowed, such that the transparent sensing thin film 502 on the non-display area can be utilized for realizing the key pads KPD_1˜KPD_8 and the sensing units SNS_1˜SNS_8. However, how to realize the key pads KPD_1˜KPD_8 and the sensing units SNS_1˜SNS_8 are not the subject matter of the present invention, and is not limited to this.

Besides, the amount of the key pads and sensing units are not limited, as long as the touch positions of the user can be correctly determined. Take FIG. 2A for example, the portable electronic display device 20 can only include the keypads KPD_3˜KPD_6 and sensing units SNS_3˜SNS_6 on the lower side and the right side. Under such a situation, as long as the keypads KPD_3˜KPD_6 are properly denoted, such that the user can correctly touch proper sensing units, and the control module 208 can correctly switch the display direction of the screen 200 or the definitions of the key pads KPD_3˜KPD_6 as well.

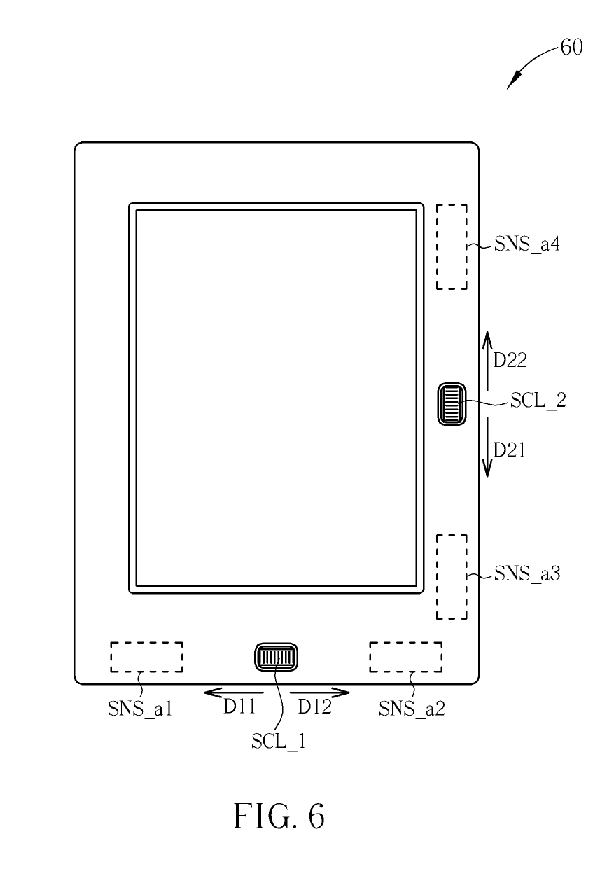

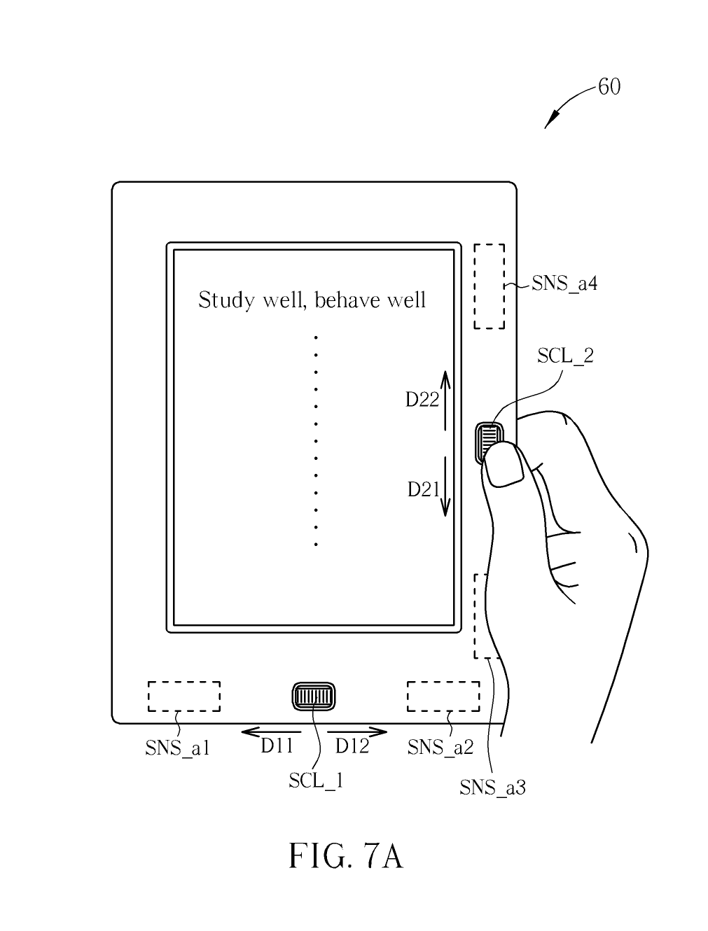

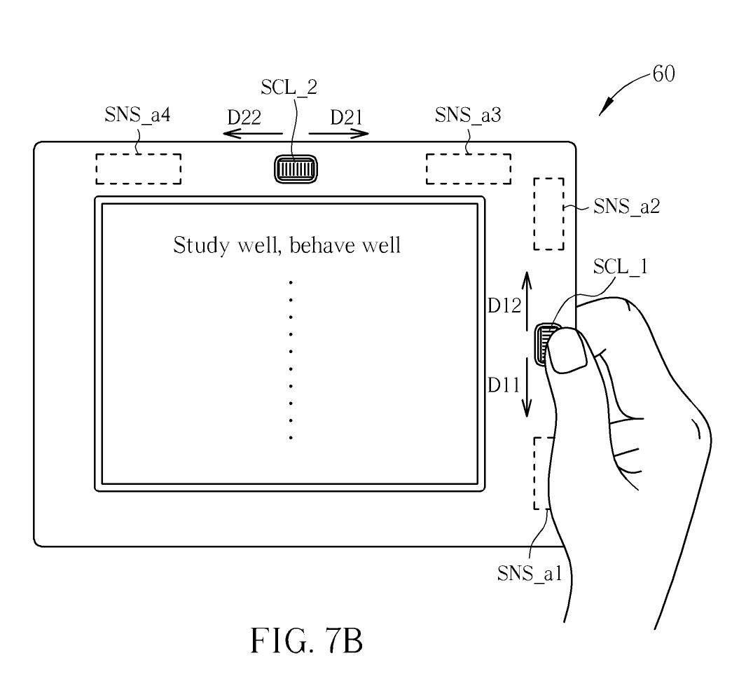

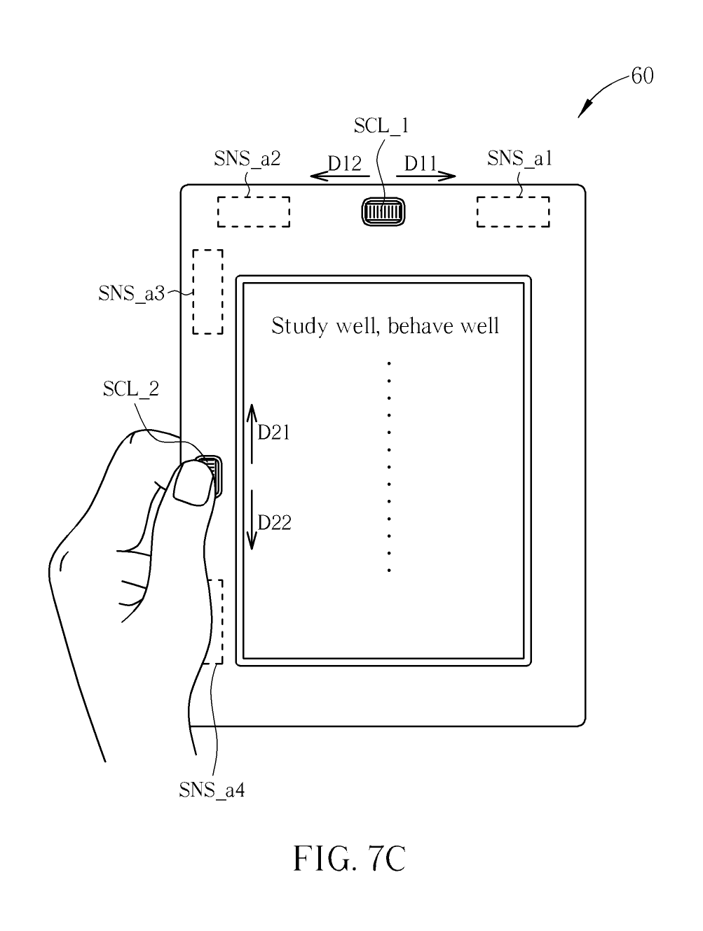

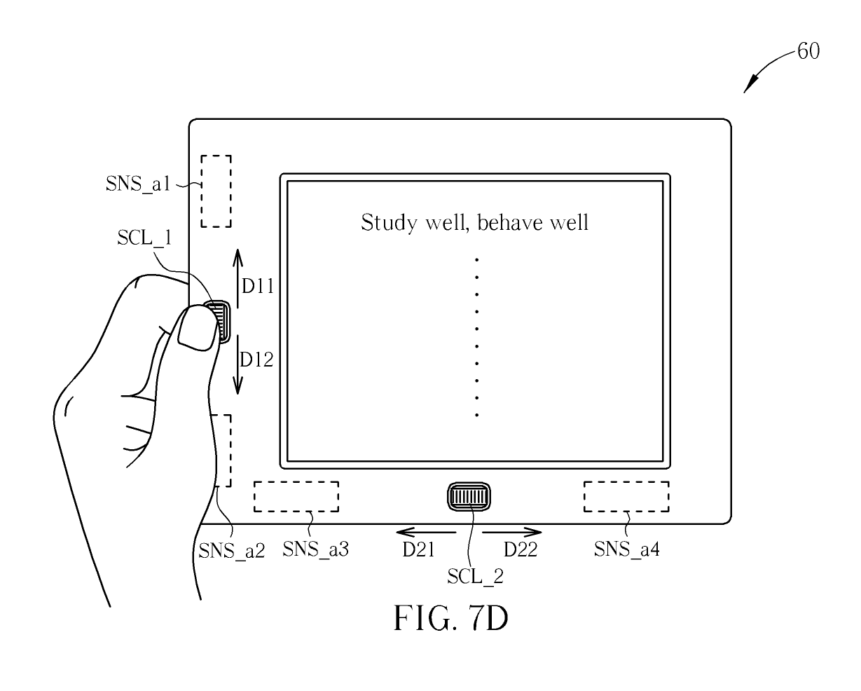

As can be seen from the above, material, appearances, the number, realizations of the key pads are not limited to specific rules, as long as the objective of the present invention can be achieved. For example, FIG. 6 is a schematic diagram of another portable electronic display device 60 according to an embodiment of the present invention. The structure and operations of the portable electronic display device 60 are similar to those of the portable electronic display device 20, and the difference is only that sensing units SNS_a1˜SNS_a4 and rollers SCL_1, SCL_2 are deposited on the lower side and the right side of the portable electronic display device 60. Therefore, corresponding operations can be summarized in FIG. 7A to FIG. 7D. The rollers SCL_1, SCL_2 can be rolled toward directions D11, D12 and D21, D22, respectively. In FIG. 7A, when the right hand touches the sensing unit SNS_a3, the portable electronic display device 60 can determine that the user adopts the vertical reading mode, so as to display the digital contents in the vertical display mode, and define the roller SCL_2 rolling toward the direction D22 as “page up”, and the roller SCL_2 rolling toward the direction D21 as “page down”. In FIG. 7B, when the right hand touches the sensing unit SNS_a1, the portable electronic display device 60 can determine that the user adopts the horizontal reading mode, so as to display the digital contents in the horizontal display mode, and define the roller SCL_1 rolling toward the direction D12 as “page up”, and the roller SCL_1 rolling toward the direction D11 as “page down”. In FIG. 7C, when the left hand touches the sensing unit SNS_a4, the portable electronic display device 60 can determine that the user adopts the vertical reading mode (which is upside down in comparison to FIG. 7A), so as to display the digital contents in the vertical display mode, and define the roller SCL_2 rolling toward the direction D21 as “page up”, and the roller SCL_2 rolling toward the direction D22 as “page down”. In FIG. 7D, when the left hand touches the sensing unit SNS_a2, the portable electronic display device 60 can determine the user adopts the horizontal reading mode (which is upside down in comparison to FIG. 7B), so as to display the digital contents in the horizontal display mode, and define the roller SCL_1 rolling toward the direction D11 as “page up”, and the roller SCL_1 rolling toward the direction D12 as “page down”.

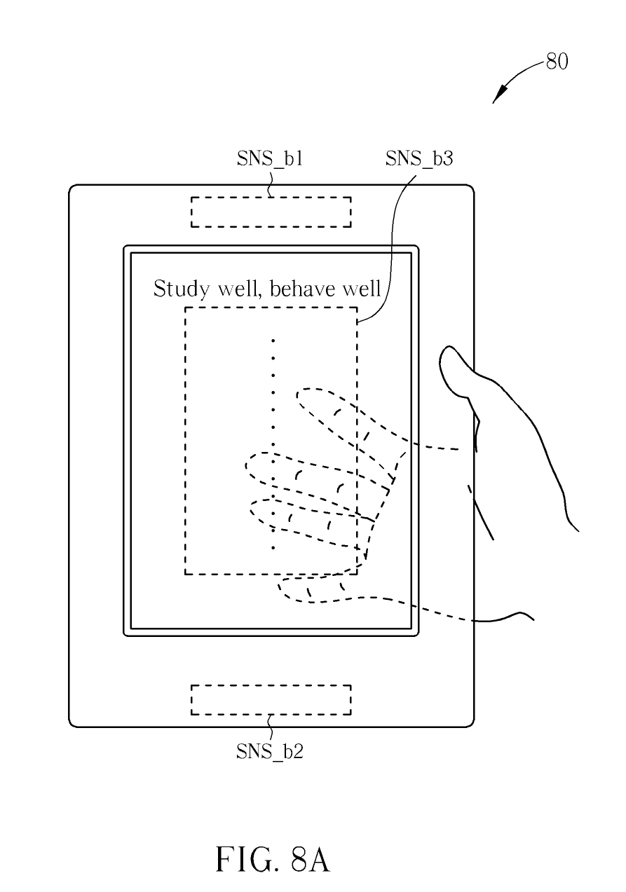

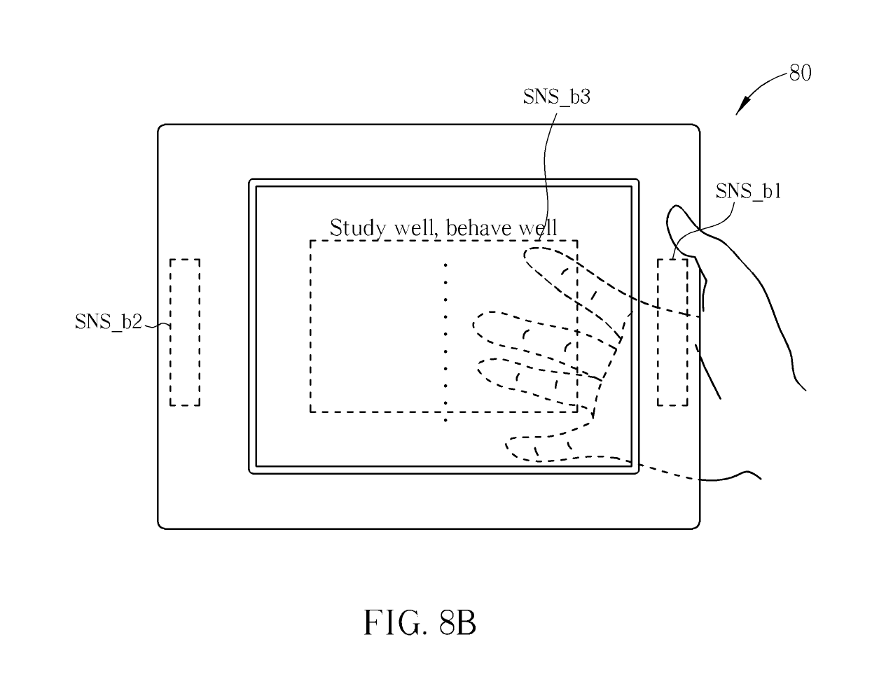

Other than deposited around the screen, the sensing units can be deposited on the back side of the screen as well. For example, FIG. 8A and FIG. 8B are schematic diagrams of a portable electronic display device 80 in two operating modes according to an embodiment of the present invention. The portable electronic display device 80 includes sensing units SNS_b1˜SNS_b3, whereas the sensing units SNS_b1, SNS_b2 are deposited on the upper side and lower side of the screen, and the sensing unit SNS_b3 is deposited on the back side of the screen. By doing so, as shown in FIG. 8A, if only the sensing unit SNS_b3 on the back side receives touch signals, a vertical display status can be determined; as shown in FIG. 8B, if both the sensing units SNS_b1, SNS_b3 receive touch signals, a horizontal display status can be determined. Other operations, such as alterations of the left hand and the right hand or determination methods should be derived from the above examples, and are not narrated hereinafter.

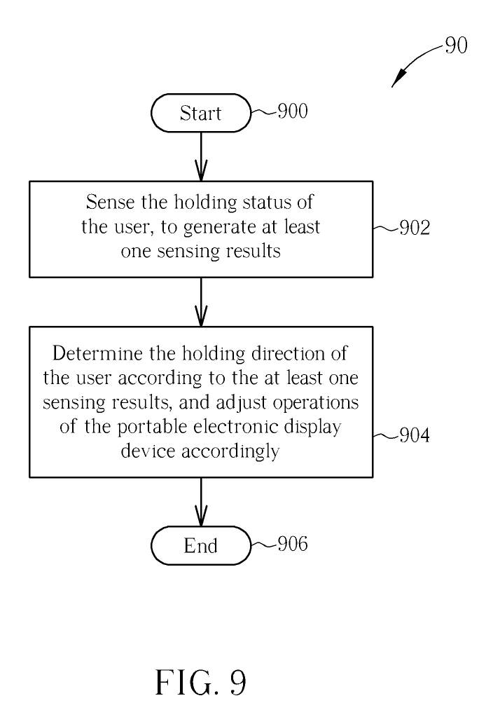

The above operations of the portable electronic display devices are utilized for illustrating the concept of the present invention, and can be further summarized into a driving process 90, as shown in FIG. 9. The driving process 90 can adapt to the holding direction of the user and drive a portable electronic display device. The driving process 90 includes the following steps:

Step 900: Start.

Step 902: Sense the holding status of the user, to generate at least one sensing results.

Step 904: Determine the holding direction of the user according to the at least one sensing results, and adjust operations of the portable electronic display device accordingly.

Step 906: End.

Detailed descriptions and alterations of the driving process 90 can be referred to above description, and are not narrated hereinafter for simplicity.

In the prior art, the key pads and the screen of the electronic book (E-book) are often deposited in fixed locations, and functions cannot be altered, which indirectly limits the holding manner and operations of the user, causing great inconvenience. In comparison, the present invention can sense the holding direction of the user, and adaptively adjust the operations of the E-book. Therefore, the present invention can effectively enhance convenience of the E-book, especially under the circumstance of operating with one hand.

To sum up, the present invention can sense the holding direction of the user, and adaptively adjust operations of the E-book, so as to enhance the convenience of the E-book.

Those skilled in the art will readily observe that numerous modifications and alterations of the device and method may be made while retaining the teachings of the invention.

What is claimed is:

1. A driving device for a portable electronic display device, capable of adapting to a holding direction of a user and driving the portable electronic display device, the driving device comprising:
a plurality of sensing units, deposited at edges of the portable electronic display device, for sensing a holding status of the user, to generate a plurality of sensing results; and
a control module, for determining the holding direction of the user according to the plurality of sensing results, and adjusting operations of the portable electronic display device accordingly.

2. The driving device of claim 1, wherein the plurality of sensing units are a plurality of optical resistors, a plurality of infrared receivers or a plurality of capacitive sensing wires, for sensing touch positions of the user.

3. The driving device of claim 1, wherein the plurality of sensing units are formed by a part of a touch screen of the portable electronic display device.

4. The driving device of claim 1, wherein one of the plurality of sensing units is deposited on a back side of the portable electronic display device relative to a screen.

5. The driving device of claim 1, wherein the control module adjusts a direction of a digital content displayed by the portable electronic display device according to the holding direction of the user.

6. The driving device of claim 1, wherein the control module adjusts definitions of a plurality of key pads of the portable electronic display device according to the holding direction of the user.

7. A portable electronic display device capable of adapting to a holding direction of a user and operating, comprising:
a screen;
an image processing unit, for displaying a digital content via the screen;
a plurality of keypads, for controlling the image processing unit; and
a driving device, comprising:
a plurality of sensing units, deposited at edges of the portable electronic display device, for sensing a holding status of the user, to generate a plurality of sensing results; and
a control module, for determining the holding direction of the user according to the plurality of sensing results, and adjusting operations of the image processing unit and the plurality of key pads accordingly.

8. The portable electronic display device of claim 7, wherein the plurality of sensing units are a plurality of optical resistors, a plurality of infrared receivers or a plurality of capacitive sensing wires, for sensing touch positions of the user.

9. The portable electronic display device of claim 7, wherein the screen is a touch screen, and the plurality of sensing units are formed by a part of the touch screen.

10. The portable electronic display device of claim 7, wherein one of the plurality of sensing units is deposited on a back side of the portable electronic display device relative to the screen.

11. The portable electronic display device of claim 7, wherein the control module adjusts a direction of the digital content displayed by the image processing unit via the screen according to the holding direction of the user.

12. The portable electronic display device of claim 7, wherein the control module adjusts definitions of the plurality of key pads according to the holding direction of the user.

13. A driving method for a portable electronic display device, capable of adapting to a holding direction of a user and driving the portable electronic display device, the driving method comprising:
sensing a holding status of the user, to generate at least one sensing results; and
determining the holding direction of the user according to the at least one sensing results, and adjusting operations of the portable electronic display device accordingly.

14. The driving method of claim 13, wherein the step of sensing the holding status of the user is utilizing an optical sensing method, an infrared sensing method or a capacitive sensing method to sense touch positions of the user.

15. The driving method of claim 13, wherein the step of sensing the holding status of the user is realized by utilizing a part of a touch screen of the portable electronic display device.

16. The driving method of claim 13, wherein the step of adjusting the operations of the portable electronic display device comprises adjusting a direction of a digital content displayed by the portable electronic display device.

17. The driving method of claim 13, wherein the step of adjusting the operations of the portable electronic display device comprises adjusting definitions of a plurality of key pads of the portable electronic display device.
